(19) United States
(12) Patent Application Publication
(10) Pub. No.: US 2007/0243037 A1
(43) Pub. Date: Oct. 18, 2007

(54) Blind bolt fastener

(76) Inventor: John D. Pratt, Laguna Niguel, CA (US)

Correspondence Address: MCDONALD HOPKINS LLC, 600 Superior Avenue, East, Suite 2100, CLEVELAND, OH, 44114-2653, US

(21) Appl. No.: 11/712,023

(22) Filed: Feb. 28, 2007

Related U.S. Application Data
(60) Provisional application No. 60/777,449, filed on Feb. 28, 2006.

(51) Int. Cl. F16B 13/04; F16B 37/00

(52) U.S. Cl. 411/43; 411/427

(57) ABSTRACT

A blind bolt fastener is provided having a body, a deformable sleeve and a core bolt in threaded engagement with the deformable sleeve. The deformable sleeve has a groove formed therein. Rotation of the core bolt bulbs the deformable sleeve and moves the deformable sleeve along the body. The groove receives a tapered nose of the body and aids in completing the bulbing of the deformable sleeve. An optional drive nut is provided for preventing rotation of the body during installation of the fastener.

### CROSS-REFERENCE TO RELATED APPLICATIONS

This application claims priority from U.S. Provisional Patent Application No. 60/777,449, entitled “Blind Bolt Fastener” filed on Feb. 28, 2006, which is hereby incorporated by reference.

### FIELD OF THE INVENTION

The present invention is generally related to blind fasteners, and more particularly to blind bolt fasteners having a body and a deformable sleeve.

### BACKGROUND OF THE INVENTION

Blind fasteners are used in a variety of applications to connect two or more workpieces together. In the construction of aerodynamic designs, such as control surfaces on aircraft and the like, a substantially flush surface is typically desired on the accessible side of the panels. Often, however, access to the blind side of the workpiece is not possible. Such one-sided access complicates the installation process. In these cases, the use of a blind fastener is appropriate and simplifies installation.

Typical blind fasteners comprise an internally threaded nut body and an externally threaded cylindrical core bolt in threaded engagement with the nut body. The inserted end of the core bolt has an enlarged core bolt head while the other end of the core bolt has a wrenchable portion. The fastener is inserted into aligned apertures of a pair of workpieces and the core bolt is rotated with respect to the nut body. The core bolt moves axially in an outward direction through the nut body. This axially outward movement typically causes a deformable sleeve around the core bolt and intermediate the nut body and core bolt head to deform about the nut body to provide a blind side head against the inner surface of the inner work piece. The core bolt further is provided with a localized weakened region or break groove adapted to sever the core bolt at a predetermined amount of torque and location.

It is advantageous that the break groove shears the core bolt in a substantially flush relation to the fastener body head after the fastener is fully set. Particularly, an accurate core bolt break is sought for fasteners having countersunk body heads to provide a flush relationship between the set fastener and the outer panel, thus providing a smooth aerodynamic surface after the fastener is set.

However, due to numerous factors including variations in combined panel thickness, sometimes the break groove on the core bolt extends beyond a flush position with the fastener body head. Therefore, when shear or breakage occurs at the break groove, a portion of the remaining core bolt may protrude beyond the fastener body head. Accordingly, it is often necessary to grind the protruding core bolt so that the core bolt is flush with the fastener body head. Prevention of such protrusion will provide a cost savings through the elimination of additional operations and manpower required in shaving, smoothing and trimming the protruding core bolt stem to provide a flush finish.

Conversely, positioning the break groove to break below the head surface can result in cavities that must be filled. Again, eliminating the need to fill such cavities will provide a cost savings through the elimination of additional operations and manpower required to provide a flush finish. In addition, low (below flush) breaks may result in some loss of strength in the fastener head.

Additionally, structural joints should have strengths at least equivalent to the panels in which they are installed. Otherwise, the fasteners will fail prior to panel failure in an overload situation. As most airframe joints are designed to carry shear loads, the joint shear strengths should be in line with the structure material bearing load strength. The shear load capability of a structural joint is usually measured using Metallic Materials Property Development and Standardization (FAA/DOD MMPDS) guidelines and testing in accordance with MIL-STD-1312 Test Method #4. A load versus elongation plot of a single fastener joint is shown in FIG. 7. Generally, the higher the yield strength and ultimate strength (i.e., higher curve), the more suitable the fastener is for structural applications.

Having a relatively large residual clamp load in the joint enhances structural strength. This allows fasteners to close gaps between panels and keep them tightly clamped together as desired. High residual clamp reduces microscopic movement between metal panels during flight operations, thereby minimizing the likelihood that fretting and fatigue cracks will develop.

Laminated carbon fiber composites are becoming increasingly prevalent in airframe structure because these composites provide lighter weight and accompanying fuel savings. Composites, however, cannot endure the high compressive stresses induced by the installation of conventional fasteners designed for metallic structure. It is, therefore, desired to spread the fastener clamp loads over a large region on the panels to minimize contact stresses while maintaining high clamp loads.

Additional information will be set forth in the description which follows, and in part will be obvious from the description, or may be learned by practice of the invention.

### SUMMARY OF THE INVENTION

The present invention relates to a blind bolt fastener having a core bolt in threaded engagement with a deformable sleeve. The fastener has a body with an enlarged head positioned between the deformable sleeve and wrenching flats of the core bolt. The bore of the deformable sleeve is tapered and has a leading edge that may abut the end of the body. An optional drive nut having protrusions may be provided for engagement with the head of the body. Bulbing of the sleeve causes the leading edge of the sleeve to move along the length of the body. The leading edge of the sleeve engages the blunt end of the body to flatten the deformable sleeve in a completely bulbed position. The core bolt has a break groove that fractures when installation of the fastener is complete.

### DESCRIPTION OF THE DRAWINGS

Operation of the invention may be better understood by reference to the following detailed description taken in connection with the following illustrations, wherein:

FIG. 1 is a diagrammatical cross sectional view of an embodiment of a blind bolt fastener in an embodiment of the present invention;

FIG. 2 is another cross-sectional view of the fastener of FIG. 1.

FIG. 3 is a perspective view of a blind bolt fastener having a deformable sleeve and a drive nut in an embodiment of the present invention;

FIG. 4 is a side and top perspective view of a blind bolt fastener in an embodiment of the present invention;

FIG. 5 is a generally exploded view of a blind bolt fastener having a drive nut in an embodiment of the present invention;

FIG. 6 is a generally exploded view of a blind bolt fastener in a side perspective view in an embodiment of the present invention; and

FIG. 7 is a lap joint shear load versus elongation plot of a single fastener joint in an embodiment of the blind bolt fastener.

FIG. 8 illustrates a blind bolt fastener having a drive nut in another embodiment of the present invention.

FIG. 9A illustrates a cross sectional view of the blind bolt fastener of FIG. 1 installed into a pair of panels.

FIG. 9B illustrates a top view of the blind bolt fastener of FIG. 9A having a flush core bolt break at the head of the body of the fastener.

### DETAILED DESCRIPTION

While the present invention is described with reference to the embodiments described herein, it should be clear that the present invention should not be limited to such embodiments. Therefore, the description of the embodiments herein is illustrative of the present invention and should not limit the scope of the invention as claimed.

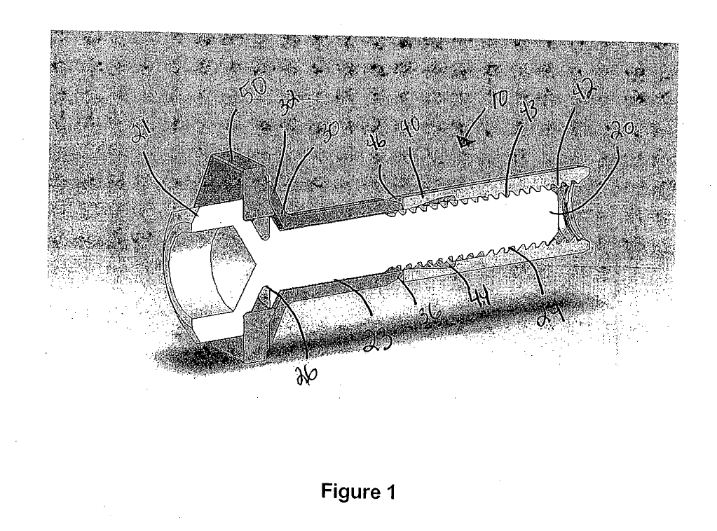

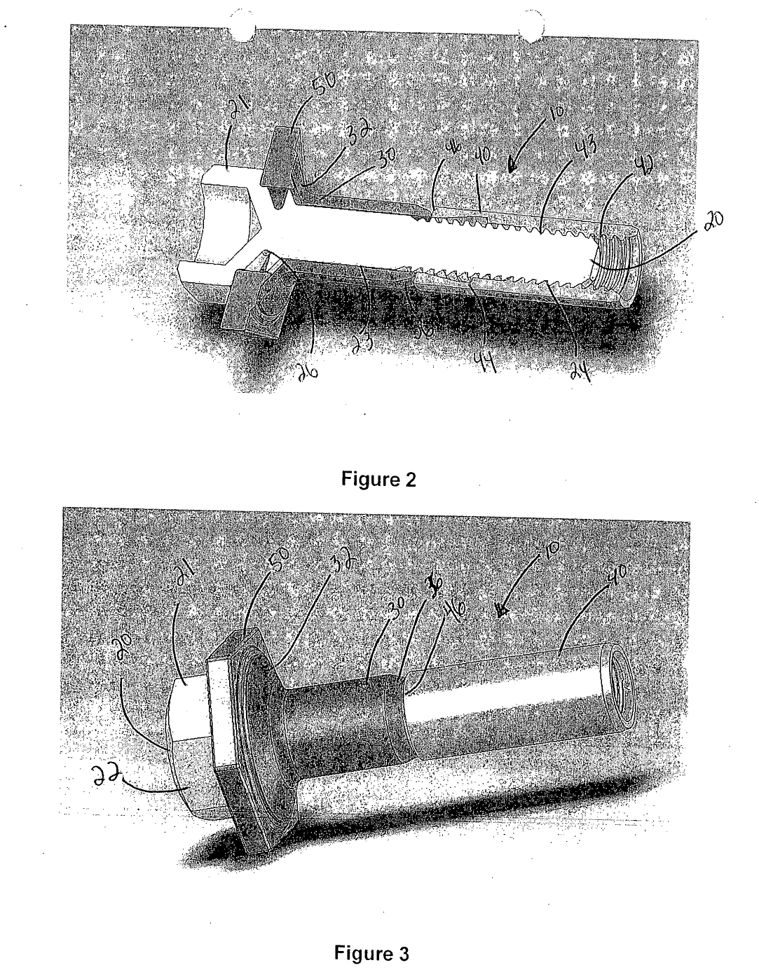

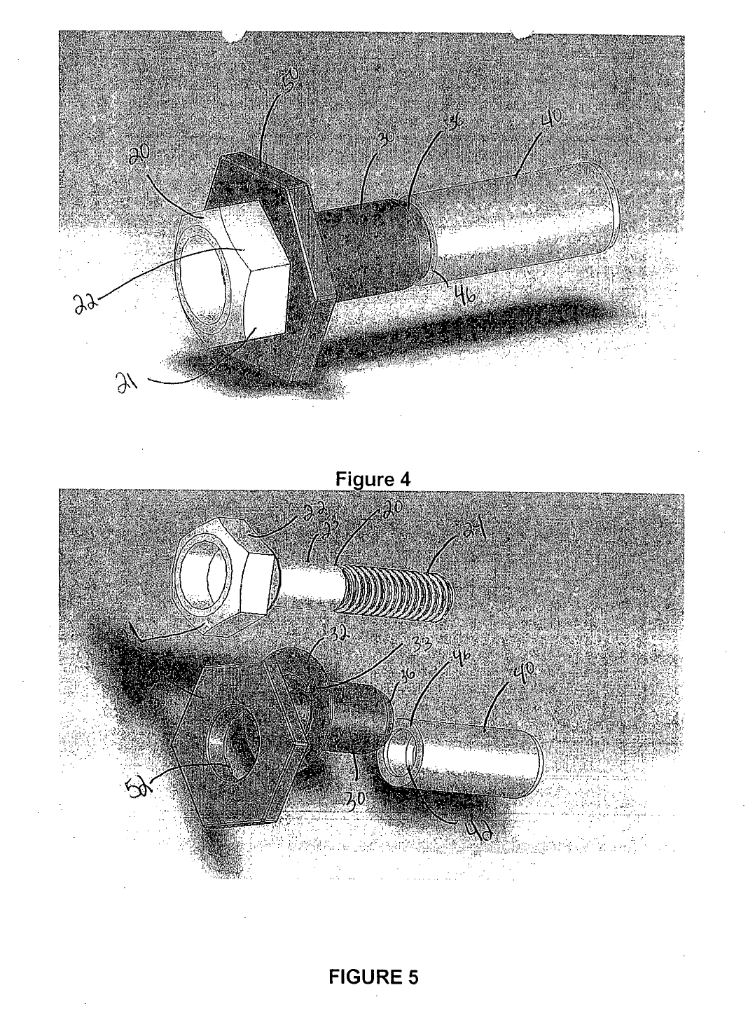

Reference will now be made in detail to the embodiments of the invention as illustrated in the accompanying figures. Embodiments of a blind bolt fastener 10 are shown in FIGS. 1 through 6. The blind bolt fastener 10 has a core bolt 20 at least partially engaged with a body 30 and a deformable sleeve 40. The core bolt 20 is threadingly engaged with the deformable sleeve 40 and rotatively engaged with the body 30. In one embodiment, the sleeve 40 abuts an end of the body 30 when assembled.

The core bolt 20 has a core bolt head 21 with a wrench engaging portion 22 on one end, as shown in FIGS. 1-6. The wrench engaging portion 22 may be enlarged wrenching flats. In an embodiment, the core bolt 20 has a non-threaded portion 23 proximate the core bolt head 21. The core bolt 20 has a threaded portion 24 that may be adjacent the non-threaded portion 23 and distal the core bolt head 21. In one embodiment, the threaded portion 24 of the core bolt 20 has buttress threads.

Further, the core bolt 20 has a core bolt break groove 26. The core bolt break groove 26 is a weakened region in the core bolt 20 that causes the core bolt 20 to fracture at a predetermined amount of torque or stress. For example, the break groove 26 may break or fracture the core bolt 20 when a preselected amount of torque is applied to wrenching flats 22 during installation of the blind bolt fastener 10. Such fracture is designed to occur upon completion of the installation of the blind bolt fastener 10, such as, when the torque required to deform the sleeve 40 exceeds the torsional strength of the break groove 26.

The core bolt 20 is insertable through the body 30. The body 30 may be sized to allow the core bolt 20 to rotate within the body 30. The body 30 has an enlarged head 32 (hereinafter “the body head 32”) at one end, such as, the end adjacent the wrenching flats 22 of the core bolt 20 when assembled. The body head 32 is capable of seating in a cavity in the access side of a pair of structural panels being fastened together. The body head 32 may be of a protruding type, setting on the surface of the access side panel.

The body 30 has a tapered nose 36. In a preferred embodiment, the tapered nose 36 is located at an opposing end of the body head 32. The outer diameter of the body 30 may taper or otherwise decrease toward the end of the body 30 adjacent the deformable sleeve 40. In an embodiment, the tapered nose 36 may abut the deformable sleeve 40.

The head 32 may have body-wrenching members 33, which are shown in FIG. 5. The wrenching members 33 may be crevices, grooves, slots or the like that are capable of engagement with a tool or drive nut that may prevent rotation of the body 30. For example, the wrenching members 33 may engage an end of a non-rotating tool that is in rotational engagement with another rotating tool used to drive the core bolt 20, and more particularly, to a tool that engages the wrenching flats 22 of the core bolt 20.

The deformable sleeve 40 may be positioned at the threaded portion 24 of the core bolt 20. The sleeve 40 may be made of a malleable material that has the ability to bulb or expand a predetermined amount without fracturing. For example, polished and annealed AISI 304 stainless steel is able to undergo a strain of approximately 100% without fracturing. Alternatively, Commercially-Pure Titanium, 300-Series Stainless steel, and A-286 Corrosion and Heat Resisting Steel can be used. The deformable sleeve 40 should not be deemed as limited to any specific material. One of ordinary skill in the art will appreciate the use of various materials for the deformable sleeve 40.

The deformable sleeve 40 has a tapered or stepped bore 42. The bore 42 may have threads 43 capable of threaded engagement with the core bolt 20. The threads 43 of the bore 42 may be buttress threads that matingly engage the threaded portion 24 of the core bolt 40. The buttress threads incorporate a steep pressure flank and a shallow non-pressure flank. For example, the pressure flank may be approximately between 75 and 90 degrees off the axis of the core bolt 20. In an embodiment, the non-pressure flank may be approximately 45 degrees. The pitch of the thread or threads per inch may be, for example, similar to that used for the 60 degree thread used on existing threaded blind bolts, such as, threads similar to MIL-S-8879 and MIL-S-7742. The buttress profile results in a lower radial component of force so that the female threads 43 of the sleeve 40 is not forced to expand radially as much as the sleeve 40 would be required to expand if a conventional thread form were used instead. A large radial component of force can cause the female threads 43 of the sleeve 40 to become disengaged with the male threads 24 of the core bolt 20 resulting in a weaker structural connection. Use of conventional threads would require more threads in engagement than the buttress threads to provide the same strain capability; however, additional threads requires additional length and, as a result, increased weight. The buttress threads minimize undesired radial expansion of the threaded portion 43 of the sleeve 40 with a minimal amount of thread engagement. The length of engagement is driven by the shear strength of the threads, rather than by concerns over radial expansion.

The sleeve 40 may have a counter bore or groove 44. The inner diameter of the groove 44 may be greater than the inner diameter of the threaded portion 43 of the sleeve 40. The sleeve 40 may be crimped at or around the groove 44 such that an edge 46 contacts or abuts the body 30. During installation, the edge 46 engages the outer surface of the tapered nose 36 of the body 30. To this end, the edge 46 and the groove 40 aid in allowing the sleeve 40 to slide or otherwise move on the body 30 toward the body head 32. As the sleeve 40 bulbs, the groove 40 is capable of causing the sleeve 40 to completely flatten against, for example, the blind side of a panel.

The drive nut 50 is positioned between the wrenching flats 22 of the core bolt 20 and the head 32 of the body 30. For example, the drive nut 50 is positioned at the break groove 26. The drive nut 50 is trapped axially between the body head 32 and the core bolt head 21 so that the drive nut 50 remains engaged with the body head 32 throughout the installation sequence.

The drive nut 50 may be provided with protrusions 52 that extend from an underside of the drive nut 50. The protrusions 52 extend toward the body 30. In an embodiment, the protrusions 52 correspond in size and shape to engage and fit into the wrenching members 33 of the body head 32. The drive nut 50 can be positioned such that the protrusions 52 engage the body head 32 upon assembly. Failure to preposition the protrusions into the recesses may prevent the core bolt head 21 from properly seating in the body head 32 throughout the installation process.

In an another embodiment, the protrusions 52 of the drive nut 50 may be a raised deformable portion adjacent the body head 32. The deformable portion may be capable of deforming into the body head 32 during assembly of the fastener components or during installation of the fastener 10.

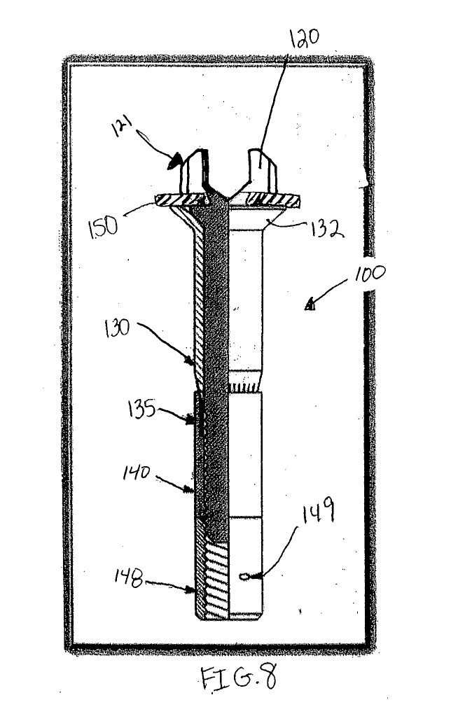

The drive nut 50 can be used on other fasteners as will be appreciated by one of ordinary skill in the art, including, without limitation, other known fasteners. In an embodiment, a drive nut 150 is used with a blind bolt fastener 100 as shown in FIG. 8. The blind bolt fastener 100 includes a core bolt 120, a body 130, an insert 135, a deformable sleeve 140, a nut 148 with a thread locking feature 149 and a drive nut 150. In this embodiment, the drive nut 150 is positioned between a body head 132 and a core bolt head 121. The drive nut 150 may have a raised deformable portion adjacent the body head 132. In an embodiment, the protrusions 52 of the drive nut 150 may deform into the body head 132 during assembly of the fastener components or alternatively during the installation.

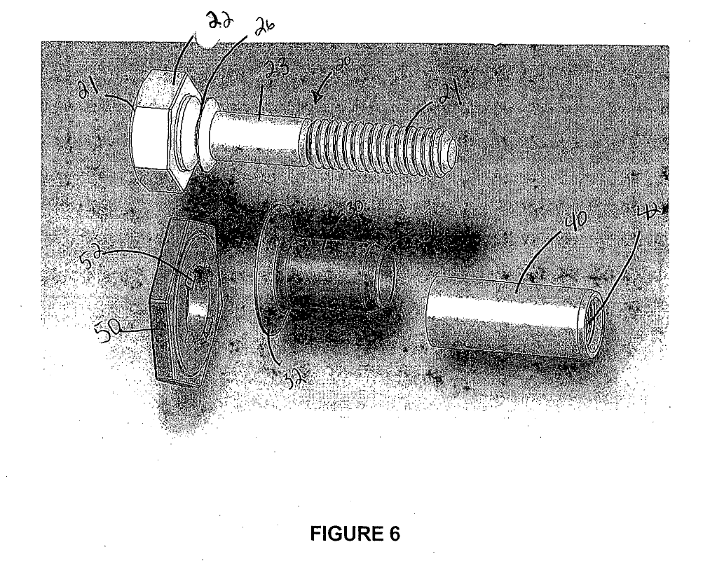

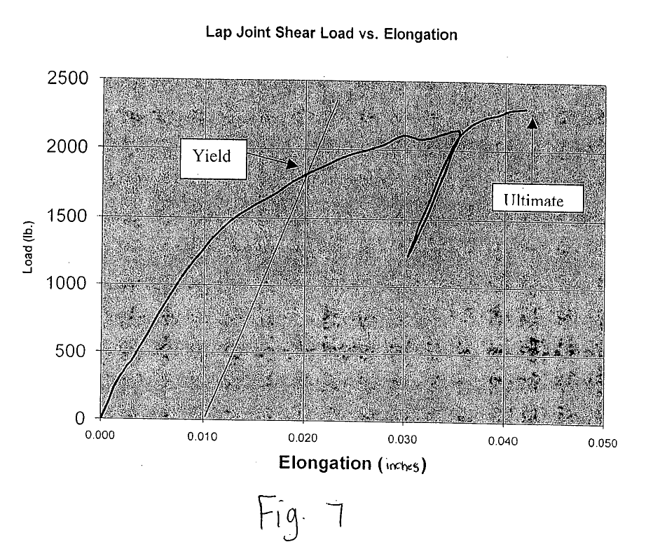

The drive nut 150 may have features similar to the drive nut 50 as illustrated in FIGS. 1-6. For example, the drive nut 150 may have protrusions, such as, the protrusions 52 as best illustrated in FIG. 6. The protrusions 52 of the drive nut 150 may fit or otherwise engage into mating devices (not shown), such as the wrenching members 33 as illustrated in FIG. 5. of the body head 132. FIG. 8 illustrates that the drive nut 150 may be positioned such that the protrusions 52 engage the body head 132 upon assembly. The protrusions 52 may engage the wrenching members 33 of the head 132 to prevent rotation of the body 130 with respect to the sleeve 140. Failure to preposition the protrusions 52 into the wrenching members 33 may prevent the core bolt head 121 from properly seating in the body head 132 throughout the installation process.

Turning to the fastener 10, an example of how to use the fastener 10 as illustrated in FIGS. 1-6 is set forth below. The drive nut 50 may be pre-positioned between the wrenching flats 21 and the body head 32. The core bolt 20 is inserted into the body 30 and into the bore 42 of the deformable sleeve 40. Torque is applied to the wrenching flats 21 of the core bolt 20 to thread the core bolt 20 into the deformable sleeve 40. The drive nut 50 may be engaged to prevent rotation of the body 32 with respect to the deformable sleeve 40. A tool assembly having a rotating wrench and non-rotating housing may engage the wrenching flats 21 and the drive nut 50, respectively. To this end, the tool may rotate the core bolt 20 and prevent rotation of the body 30 by engaging the drive nut 50. For example, the protrusions 52 of the drive nut 50 may engage the wrenching member 33 of the body 30.

The core bolt 20 rotates and is threaded into the deformable sleeve 40 causing the sleeve 40 to bulb. The tapered or stepped bore 42 controls the blind side formation of the sleeve 40. As the core bolt 20 is threaded into the sleeve 40, the sleeve 40 is driven against the tapered nose 36 of the body 30. In an embodiment, the sleeve 40 bulbs prior to moving up the body 30 toward the head 32. For example, the sleeve 40 buckles against the body 30, and then moves against the tapered nose 36 and along the body 30. In a preferred embodiment, the rotational friction force at the interface between the body 30 and sleeve 40 is greater than the rotational friction force between the threaded interface of the core bolt 20 and sleeve 40. Knurls on the body 30 may be used to enhance or increase frictional force.

The edge 46 of the sleeve 40 reaches the outer surface of the tail-side panel and as a result, the sleeve 40 flattens completely against the blind side surface and causes the strain on the core bolt 20 to increase such that the core bolt 20 fractures at the break groove 26. The residual clamp load is near maximum during formation of the blind side upset because there is no axial recoil upon torsional fracture at the break groove 26. The frangible portion of the core bolt 20 and the drive nut 50 are discarded upon completion of the installation.

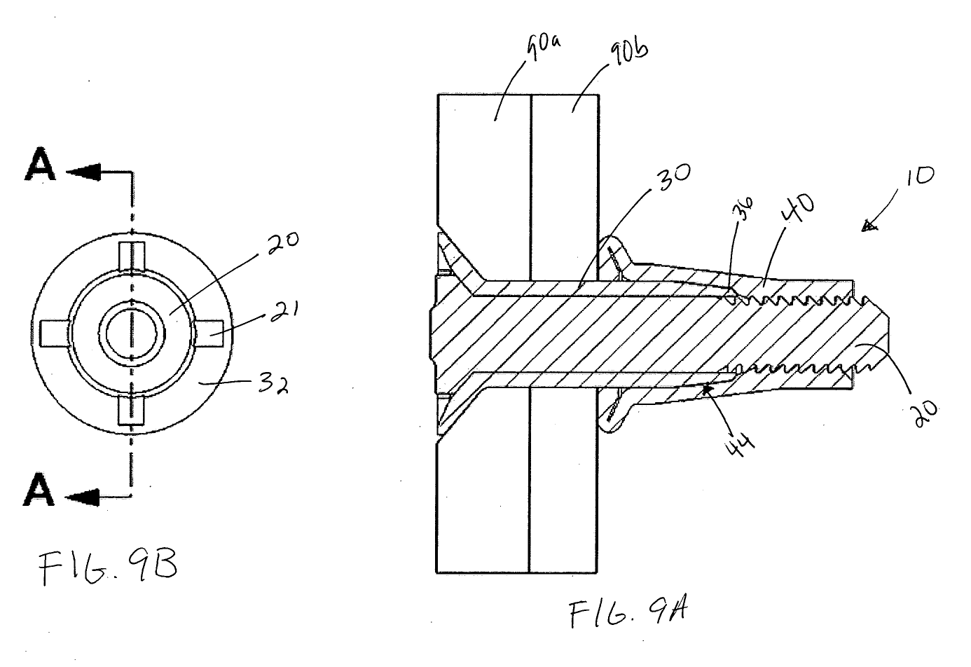

FIG. 9B illustrates an embodiment of the fastener 10 as installed into a pair of panels 90a, 90b. As illustrated, the deformable sleeve 40 bulbs against the blind side of the panel 90b. The deformable sleeve 40 moves along the body 30 to engage the tapered nose of the 36. In this embodiment, the tapered nose 36 engages the groove 44 to prevent further movement of the deformable sleeve 40 and to aid in flattening or bulbing of the deformable sleeve 40. The remaining portion of the core bolt 20 is flush with the head 32 and/or the access side of the panel 90a as illustrated in FIG. 9A.

The invention has been described above and, obviously, modifications and alternations will occur to others upon a reading and understanding of this specification. The claims as follows are intended to include all modifications and alterations insofar as they come within the scope of the claims or the equivalent thereof.

Having thus described the invention, I claim:

1. A blind bolt fastener comprising:
a core bolt having a wrench engaging portion at one end and a threaded portion at the opposite end; and
a deformable sleeve in threaded engagement with the core bolt; and
a body positioned between the deformable sleeve and the wrench engaging portion wherein rotation of the core bolt causes the deformable sleeve to move along the body toward the wrench engaging portion.

2. The blind bolt fastener of claim 1 further comprising:
a groove formed in the deformable sleeve wherein an end of the body engages the groove to flatten the deformable sleeve.

3. The blind bolt fastener of claim 2 wherein the body has a tapered nose at the end of the body that engages the groove.

4. The blind bolt fastener of claim 3 wherein the body has an enlarged head at the end of the body opposite to the tapered nose.

5. The blind bolt fastener of claim 4 wherein the enlarged head has wrenching members formed therein.

6. The blind bolt fastener of claim 1 further comprising:
a drive nut having protrusions capable of engaging the wrenching members of the enlarged head to prevent rotation of the body.

7. The blind bolt fastener of claim 6 wherein the protrusions are deformable into the wrenching members.

8. The blind bolt fastener of claim 6 wherein the sleeve has a leading edge that moves axially along the body toward the enlarged head.

9. The blind bolt fastener of claim 8 wherein the sleeve has a tapered bore.

10. The blind bolt fastener of claim 9 wherein the sleeve has female buttress threads and the core bolt has male buttress threads.

11. A blind bolt fastener comprising:
a body;
a core bolt capable of moving axially through the body; the core bolt having a wrenching engaging portion at one end and a threaded portion at the opposite end; and
a deformable sleeve having a bore and a counterbore formed therein, the bore having a threaded portion capable of engaging the threaded portion of the core bolt, wherein the counter bore is capable of receiving a portion of the body.

12. The blind bolt fastener of claim 11 wherein rotation of the core bolt causes the deformable sleeve to move along the body.

13. The blind bolt fastener of claim 11 wherein the body has an enlarged head at one end and a tapered nose at the opposing end.

14. The blind bolt fastener of claim 13 wherein tapered nose moves within the counterbore upon rotation of the core bolt.

15. The blind bolt fastener of claim 13 wherein the enlarged head has wrenching members.

16. The blind bolt fastener of claim 15 further comprising:
a drive nut having protrusions capable of engaging the wrenching members to prevent rotation of the body with respect to the sleeve.

17. The blind bolt fastener of claim 16 wherein the drive nut is trapped between the wrenching portion of the core bolt and the enlarged head of the body.

18. A blind bolt fastener comprising:
a core bolt having wrenching flats at one end and a threaded portion at the opposing end;
a deformable sleeve threadingly engageable with the core bolt;
a body having an enlarged head at one end and a tapered nose at the opposing end, the core bolt extending through the body; and
a groove formed in the deformable sleeve sized for receiving the tapered nose wherein rotation of the core bolt moves the deform able sleeve along the body to engage the groove.

19. The blind bolt fastener of claim 18 wherein the deformable sleeve has an edge that slides along the length of the body and is prevented from moving toward the enlarged head of the body by the engagement of the tapered nose and the groove.

20. The blind bolt fastener of claim 18 further comprising:
a drive nut capable of engaging the enlarged head of the body to prevent rotation of the body.
